(19) United States
(12) Patent Application Publication
(10) Pub. No.: US 2015/0339949 A1
(43) Pub. Date: Nov. 26, 2015

(54) HEALTH AND FITNESS TRACKER MODULE SOFTWARE PLATFORM

(71) Applicant: Matthew Landers, Edgewater, NJ (US)

(72) Inventor: Matthew Landers, Edgewater, NJ (US)

(21) Appl. No.: 14/282,944

(22) Filed: May 20, 2014

(51) Int. Cl. G09B 19/00

(52) U.S. Cl. CPC G09B 19/0092

(57) ABSTRACT

Disclosed is a system, method, and non-transitory computer readable storage medium to view, analyze, and manipulate a patient's food consumption characteristics, activity characteristics, etc. and communicate with the patient regarding these characteristics. A health and fitness tracker module executed by a processor from a health and fitness tracker application (executing on a client device) repeatedly receives data associated with a user of the fitness tracker application. An individual uses the fitness tracker module to manipulate the data to generate fitness tracker module data, the fitness tracker module data comprising an overview, behavioral statistics, and comparative statistics. The individual graphs a portion of the fitness tracker module data into one or more graphical representations of a portion of data of the fitness tracker application.

### FIELD

The present disclosure relates to a software platform, and more specifically to a health and fitness tracker module software platform.

### BACKGROUND

Medical professionals, such as gym trainers, doctors, nurses, nutritionists, etc., often have a difficult time determining whether a patient is following the prescribed health and fitness routine. There is typically no clear way for a medical professional to see what types of food the patient is eating, what exercises the patient is performing, the duration of the activities, the frequency of meals, etc. Additionally, a medical professional usually has no easy way to communicate with the patient after determining this information without calling or emailing the patient or waiting for the patient's next visit with the medical professional. As a result, there remains a need for a better way for a medical professional to determine this information and to communicate with the patient instructions on how to improve the patient's health to meet the patient's goals.

### SUMMARY

The present disclosure relates to a system, method, and computer readable storage medium for a medical professional to view, analyze, and manipulate a patient's food consumption characteristics, activity characteristics, etc. and communicate with the patient regarding these characteristics.

According to one aspect, the described invention provides a method comprising: repeatedly receiving, by a fitness tracker module executed by a processor from a fitness tracker application executing on a client device, data associated with a user of the fitness tracker application; manipulating, by an individual using the fitness tracker module, the data to generate fitness tracker module data, the fitness tracker module data comprising an overview, behavioral statistics, and comparative statistics; graphing, by the individual, a portion of the fitness tracker module data into one or more graphical representations of a portion of data of the fitness tracker application; and communicating, by the fitness tracker module, at least a portion of the fitness tracker module data to the client device for display.

According to one embodiment, the fitness tracker application obtains the data from communication with a device comprising a motion sensor (e.g., a programmable accelerometer). According to another embodiment, the fitness tracker application displays a fitness arc indicating energy excess and energy deficit of the user during a first predetermined time period.

According to one embodiment, the user wears the device.

According to one embodiment, the method further comprises graphing, by the processor, data corresponding to the fitness arc in a line graph over a second predetermined time period. According to another embodiment, the method further comprises displaying, by the processor, data points in display boxes showing a snapshot of the user's health characteristics during the second predetermined time period.

According to one embodiment, the health characteristics comprise a health characteristic type selected from a group of health characteristic types consisting of activity, health quotient, food intake, weight, bad carbohydrates, good carbohydrates, protein, fat, fluid, vitamins, salt, and vitamin K. According to another embodiment, the activity is selected from the group consisting of sleeping, walking, jogging, running, biking, tennis, basketball, soccer, circuit training, elliptical training, weight lifting, yoga, Pilates and resistance training.

According to one embodiment, the behavioral statistics further comprises a statistic selected from a group of statistic types consisting of aerobic, anaerobic, routine activity, unique meals, favorite meals, number of food entries, average time between meals, number of activity entries, and average exercise duration.

According to one embodiment, the graphing of the portion of the fitness tracker module data further comprises enabling selection, by the individual, of a plurality of comparative statistics selections from food intake data points, activity data points, and summary data.

According to another aspect, the described invention provides a computing device comprising: a processor; a storage medium for tangibly storing thereon program logic for execution by the processor, the program logic comprising: receiving logic executed by a fitness tracker module executed by a processor from a fitness tracker application executing on a client device, for repeatedly receiving data associated with a user of the fitness tracker application; manipulating logic executed by the fitness tracker module for manipulating, by a individual, the data to generate fitness tracker module data, the fitness tracker module data comprising an overview, behavioral statistics, and comparative statistics; graphing logic executed by the processor for graphing, by the individual, a portion of the fitness tracker module data into one or more graphical representations of a portion of data of the fitness tracker application; and communication logic executed by the processor for communicating, by the fitness tracker module, at least a portion of the fitness tracker module data to the client device for display.

According to one embodiment, the fitness tracker application obtains the data from communication with a motion sensing device (e.g., a programmable accelerometer). According to another embodiment, the fitness tracker application displays a fitness arc indicating energy excess and energy deficit of the user during a first predetermined time period.

According to one embodiment, the computing device further comprises fitness arc graphing logic executed by the processor for graphing data corresponding to the fitness arc in a line graph over a second predetermined time period.

According to one embodiment, the computing device further comprises display logic executed by the processor for displaying data points in display boxes showing a snapshot of the user's health characteristics during the second predetermined time period.

According to one embodiment, the health characteristics comprise a health characteristic type selected from a group of health characteristic types consisting of activity, health quotient, food intake, weight, bad carbohydrates, good carbohydrates, protein, fat, fluid, vitamins, salt and vitamin K. According to another embodiment, the activity is selected from the group consisting of sleeping, walking, jogging, running, biking, tennis, basketball, soccer, circuit training, elliptical training, weight lifting, yoga, Pilates and resistance training.

According to one embodiment, the behavioral statistics further comprises a statistic selected from a group of statistic types consisting of aerobic activity, anaerobic activity, routine activity, unique meals, favorite meals, number of food entries, average time between meals, number of activity entries and average exercise duration. According to another embodiment, the aerobic activity is selected from the group consisting of walking, jogging, running, biking, tennis, basketball, soccer, circuit training and elliptical training According to another embodiment, the anaerobic activity is selected from the group consisting of weight lifting, yoga, Pilates and resistance training. According to another embodiment, the routine activity is sleep.

According to one embodiment, the graphing logic for graphing the portion of the fitness tracker module data further comprises selecting logic executed by the processor for enabling selection, by the individual, of a plurality of comparative statistics selections from food intake data points, activity data points and summary data. According to another embodiment, the activity data points are selected from data points for such activities as sleeping, walking, jogging, running, biking, tennis, basketball, soccer, circuit training, elliptical training, weight lifting, yoga, Pilates and resistance training.

According to another aspect, the described invention provides a non-transitory computer readable storage medium tangibly storing computer program instructions capable of being executed by a computer processor, the computer program instructions defining the steps of: repeatedly receiving, by a fitness tracker module executed by a processor from a fitness tracker application executing on a client device, data associated with a user of the fitness tracker application; manipulating, by a individual using the fitness tracker module, the data to generate fitness tracker module data; graphing, by the individual, a portion of the fitness tracker module data into one or more graphical representations of a portion of data of the fitness tracker application; and communicating, by the fitness tracker module, at least a portion of the fitness tracker module data to the client device for display.

According to one embodiment, the fitness tracker application obtains the data from communication with a device comprising a motion sensor (e.g., a programmable accelerometer). According to another embodiment, the fitness tracker application displays a fitness arc indicating energy excess and energy deficit of the user during a first predetermined time period.

These and other aspects and embodiments will be apparent to those of ordinary skill in the art by reference to the following detailed description and the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawing figures, which are not to scale, and where like reference numerals indicate like elements throughout the several views:

FIG. 1 is a schematic diagram illustrating an example system of a network and devices implementing embodiments of the present disclosure;

FIG. 2 is a flowchart illustrating steps performed by the system of FIG. 1 in accordance with an embodiment of the present disclosure;

FIG. 3 is an illustration of a fitness arc information screen in accordance with an embodiment of the present disclosure;

FIG. 4 is a screen shot provided on a website associated with a health and fitness tracker module in accordance with an embodiment of the present disclosure;

FIG. 5 shows a screen shot illustrating a behavior statistics screen displayed by the health and fitness tracker module in accordance with an embodiment of the present disclosure;

FIG. 6 illustrates a comparative statistics screen shot for a medical professional to select variables to measure against one another in accordance with an embodiment of the present disclosure;

FIG. 7 shows the medical professional selecting three variables to plot against each other—protein, weightlifting activity, and weight, in accordance with an embodiment of the present disclosure;

FIG. 8 shows a plot of the weight represented as line graph, weightlifting activity data shown as one bar graph, and protein intake data shown as another bar graph in accordance with an embodiment of the present disclosure;

FIG. 9 shows a main comparative statistics screen showing a saved graphs section in which the medical professional can save graphs that will likely be plotted or graphed often in accordance with an embodiment of the present disclosure;

FIG. 10 shows a notes display illustrating created notes in accordance with an embodiment of the present disclosure;

FIG. 11 depicts one example of a schematic diagram illustrating a client device in accordance with an embodiment of the present disclosure; and

FIG. 12 is a block diagram illustrating an internal architecture of a computer in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

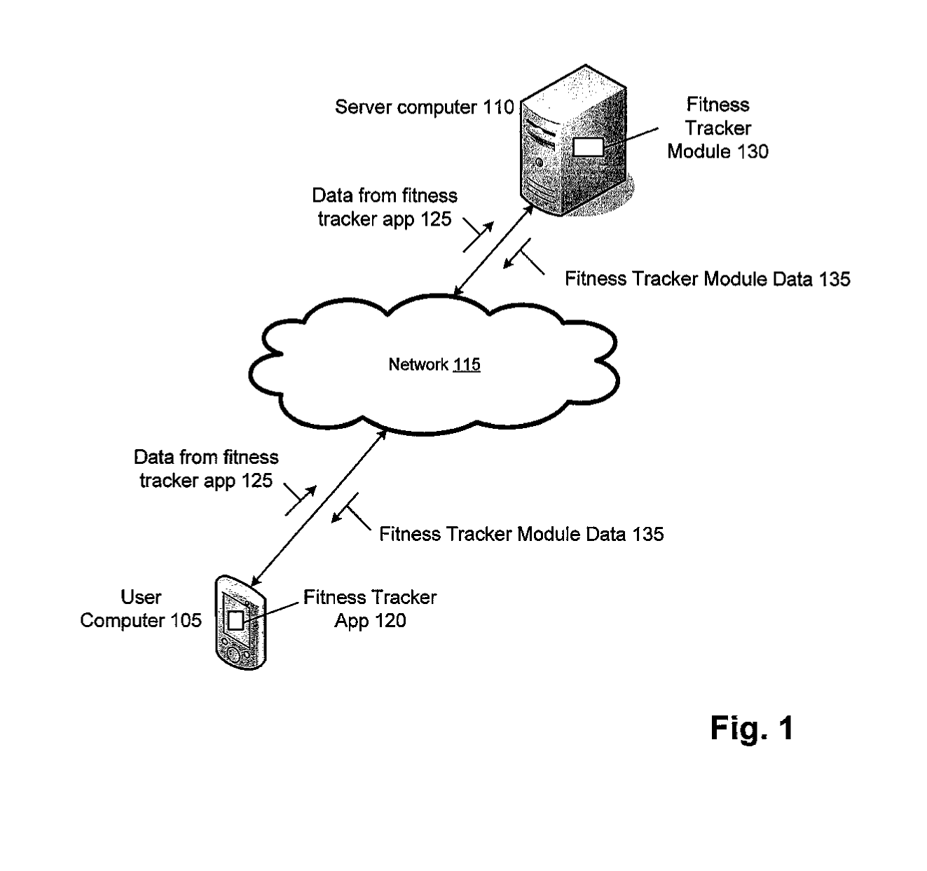

FIG. 1 is a schematic diagram illustrating an example system 100 of a network and devices implementing embodiments of the present disclosure. Other embodiments that may vary, for example, in terms of arrangement or in terms of type of components, are also intended to be included within claimed subject matter. FIG. 1 includes, for example, a user computer 105 in communication with a content server 110 over a wireless network 115 connected to a local area network (LAN)/wide area network (WAN), such as the Internet. Content server 110 is also referred to below as server computer 110 or server 110. In one embodiment, the user computer 105 is also in communication with an advertisement server (not shown) that can provide advertisements to the user computer 105. Although shown as a wireless network 115 (and WAN/LAN), the user computer 105 can communicate with server 110 via any type of network.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Examples of devices that may operate as a content server include desktop computers, multiprocessor systems, microprocessor-type or programmable consumer electronics, etc. Content server 110 may provide a variety of services that include, but are not limited to, web services, third-party services, audio services, video services, email services, instant messaging (IM) services, SMS services, MMS services, FTP services, voice over IP (VOIP) services, calendaring services, photo services, social media services, or the like. Examples of content may include text, images, audio, video, or the like, which may be processed in the form of physical signals, such as electrical signals, for example, or may be stored in memory, as physical states, for example. In one embodiment, the content server 110 hosts or is in communication with a database.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LIE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

In one embodiment and as described herein, the user computer 105 is a smartphone. In another embodiment, the user computer 105 is a tablet. The user computer 105 may also be a wearable computing device, such as glasses (e.g., Google® Glass®) or a watch.

In one embodiment, the user computer 105 downloads a health and fitness tracker app 120 (referred to herein as fitness tracker app 120 or app 120) (e.g., from the server 110, from an app store such as the Apple® app store or Google® Play® app store, etc.). The fitness tracker app 120 synchronizes with a health and fitness tracker (referred to herein as fitness tracker). In one embodiment, the fitness tracker includes a motion sensor (e.g., a programmable accelerometer) that the user wears (e.g., on the user's neck, on the user's wrist, on the user's calf, on the user's leg, on the user's arm, etc.). The fitness tracker can determine what activity the user is performing (e.g., walking, running, eating, aerobic activity, anaerobic activity, etc.), the duration of the activity, health information, and any other statistic or characteristic associated with an activity or health of the user.

The fitness tracker communicates this information to the fitness tracker app 120. In one embodiment, the fitness tracker communicates this information to the fitness tracker app 120 continuously, periodically, at a scheduled time, in real-time or near real-time, etc. The fitness tracker app 120 obtains the data from the fitness tracker and, as described in more detail below, analyzes the data to provide information to the user.

The fitness tracker app 120 communicates this data 125 from the user computer 105 to a fitness tracker module 130 on the server computer 110. The fitness tracker module 130 enables a medical professional to manipulate the data 125 to further analyze the data 125 into fitness tracker module data 135. In one embodiment, a medical professional can (e.g., remotely) log into a web site associated with the server 110 to analyze and manipulate the fitness tracker module data 135. As described in more detail below, the medical professional can graph one or more data points associated with the data 135, can record and/or send notes about/to the patient about the data 135 or about the patient's regimen or activities, etc.

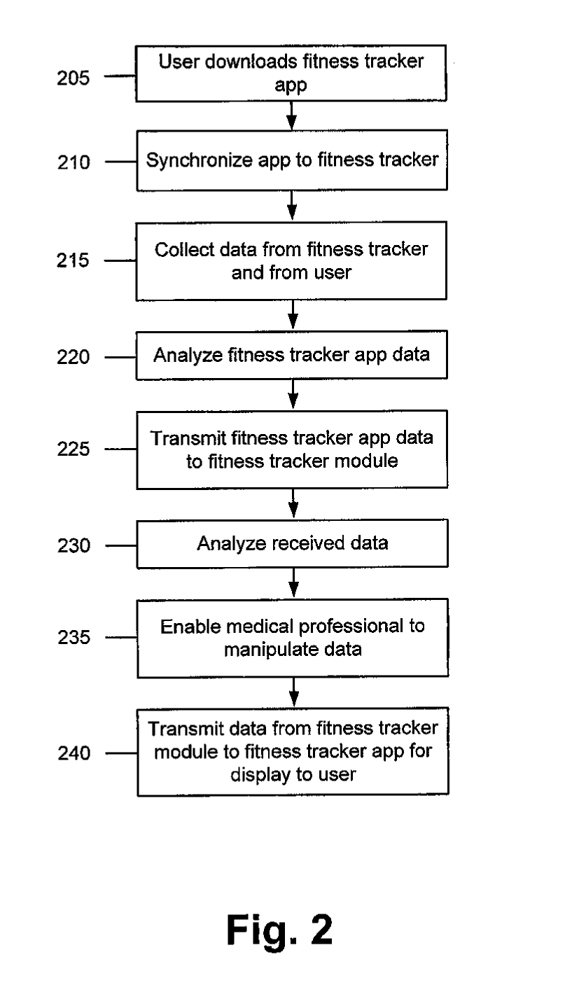

FIG. 2 illustrates an embodiment of steps performed by system 100. As described above, the user in one embodiment downloads the fitness tracker app 120 to the user computer 105 (Step 205). The user synchronizes the fitness tracker app 120 to a fitness tracker (Step 210). This synchronization may occur by pressing a button on the user computer 105 or on the app 120 displayed on the screen of the user computer 105 after turning on Bluetooth from the tracker. In another embodiment, the tracker and fitness tracker app 120 synchronize automatically when in range (e.g., every 10 minutes). Once synchronization occurs, communication begins between the fitness tracker and the fitness tracker app 120.

The app 120 collects data from the fitness tracker and from the user (Step 215). For example and as described in more detail below, the fitness tracker may communicate how long the user exercised, what exercise the user performed, a weight of the user or a representation of the weight of the user, etc. The user can also input data into the fitness tracker app 120, such as what the user is eating or going to eat, the size of the meal, etc. For example, the app 120 may display a menu of items and the user can select from the menu what the user is about to eat or has eaten. The app 120 can then display a plate of the selected menu item and the user can adjust (e.g., by pressing a “+” button or a “−” button) how much the user is about to eat or how much the user ate. The fitness tracker app 120 can take this food information and analyze the data (Step 220) to determine food characteristics, such as, for example, how much protein is present in the meal, how many “good” carbohydrates and/or how many “bad” carbohydrates are present in the meal, etc.

The app 120 then transmits (e.g., continuously, periodically, at scheduled times, etc.) the fitness tracker app data 125 to the fitness tracker module 130 (Step 225). The fitness tracker module 130 analyzes the data (Step 230) and enables a medical professional to manipulate the data (Step 235). In another embodiment, the computer 105 analyzes the data. The fitness tracker module 130 transmits (e.g., continuously, periodically, at scheduled times, etc.) the data 135 to the fitness tracker app 120 for display to the user (e.g., in real-time or near real-time).

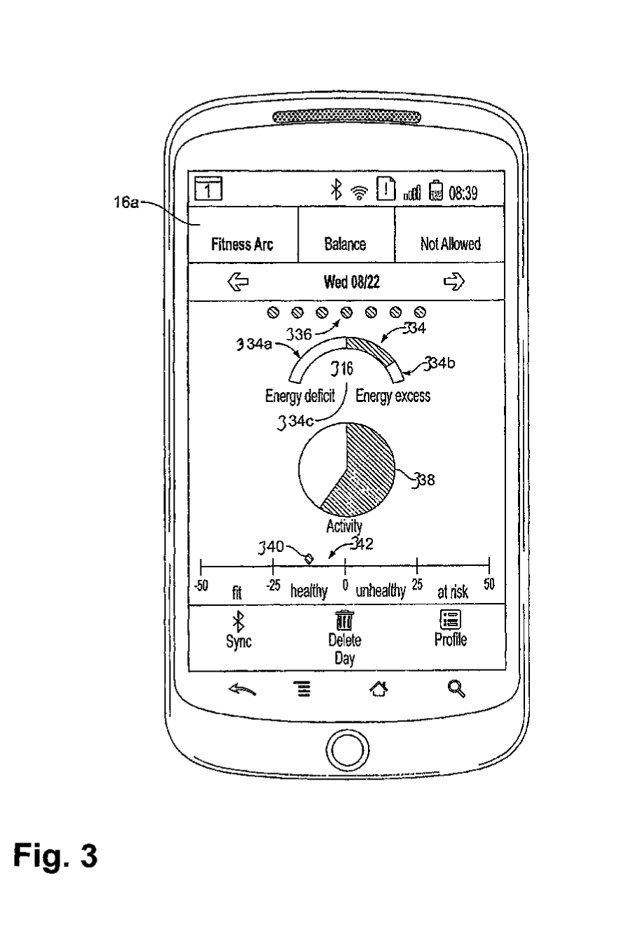

Referring to FIG. 3, the fitness tracker app data 125 can be displayed on the app 120 as a graphical display, e.g., as a graphical fitness arc 334. The fitness arc 334 can be utilized to depict a measurement of daily energy balance and provide a daily indicator of fitness and health. In an embodiment, the accuracy of the fitness arc 334 can be enhanced by the fitness tracker app 120. More particularly, the app 120 can, e.g., periodically recalculate the user's intrinsic metabolism to provide an energy balance correction. Every person has a unique and changing metabolism such that consumption of similar quantities of food and similar amounts of activity can have different effects on the weight of the user, which weight can be utilized as a fitness indicator. Thus, there can be a different amount of remaining energy units available every day for storage as fat and therefore different consequences to weight in different individuals. This discrepancy can occur even if activity and food consumption can be identical. This constitutes the meaning of intrinsic metabolism according to the presently disclosed subject matter. These parameters can be continuously varying, i.e., they can be constantly changing with resultant different effects on weight for any individual user. The app 120, by monitoring its ability to predict weight based upon the activity units and food intake input, can constantly vary the allowed food intake should the app 120 fail to accurately predict the change in the weight of the user. Thus, the continuous variable of intrinsic metabolism can, as an example, constantly be adjusted to correct for changes in the rate of energy consumption as fitness levels change or as food consumption and activity patterns change. By adjusting the metabolism calculation, the app 120 can, e.g., determine modified food allowance(s) to match changes in activity. The fitness arc is described in more detail in U.S. Pat. No. 8,600,928 and U.S. patent application Ser. No. 13/743,718 (U.S. Patent Publication No. 2013/0132319), both of which are incorporated by reference.

The fitness tracker app 120, by way of example, can work without a requirement that the food input from the user be accurately reflective of the actual calorie content of food consumed. The app 120 only requires that the user have a reasonably similar pattern of icon use to describe food intake. For example, a sandwich eaten on one day may be bigger or smaller than the same eaten the day before, but the system in one embodiment does not require the user to actually reflect the absolute caloric content consumed. The algorithm can, by way of example, learn the way the user describes food and then assign a food unit value to each food component, e.g., contained within the sandwich, based upon an algorithm utilized by the app 120. In this manner, any habitual over/under food portion estimation(s) by the user can be detected and compensated for, thereby facilitating the app 120 in maintaining or reaching a user's target weight goal as specified in a user's profile.

Continuing to refer to FIG. 3, when primary input button 316a, “fitness arc” can be selected, a color coded energy deficiency/energy excess fitness arc 334 can be displayed on the display screen of the user computer 105. In an embodiment, the fitness arc 334 can be formed in a semi-circular shape, where one side of the semi-circle can be an energy deficit portion 334a (i.e., indicative of weight loss) and the other side of the semi-circle can be an energy excess portion 334b (i.e., indicative of weight gain). In an embodiment, a red color may show when the energy deficit 334a can be present for that particular moment of the day (e.g., within periodic updates, such as 10 minute updates), and a green color may show when the energy excess 334b can be present for that day. The portions 334a, 334b of the fitness arc 334 can change throughout the day, depending on the user's indicated physical activity and indicated food consumption. In an embodiment, coincident with the update of the fitness arc 334, a fitness arc value 334c can also be displayed. This value can represent the delta or change in fitness arc 334 units with each periodic, e.g., 10 minute interval, e.g., plus for an increase in energy excess (the body can be consuming energy through activity at a higher rate than necessary based on indicated food intake and the current intrinsic metabolism of the user) and negative for an increase in energy deficit (the body can be consuming energy through activity at a lower rate than necessary based on the indicated food intake and the current intrinsic metabolism of the user). At the conclusion of each day, the fitness arc 334c final value can be displayed. It can also be understood that the value for the fitness arc can be normalized and the color coded indication on the arc 334 used to indicate the positive or negative state of the energy consumption.

The fitness arc 334, therefore, can be used to visually inform the user as to the effect of the real time food consumption of the user referenced against the real time analysis of the actual physical activities of the user. At any given point in the day, the actual activity units and their impact on the fitness arc 334 can then be referenced against expected or historic levels of activity for that same time of the day. The fitness arc 334 displays can be adjusted based upon what can be expected and what has occurred. Activity units can be measured and assigned a value based upon the currently determined value for the calculated intrinsic metabolism of the user. The activity unit's value can be then used to calculate the energy balance that also can then be used to predict weight gain or loss, even before the food consumption or activity can be carried out.

Thus, given the inherent variation between each individual's rate of intrinsic metabolism and the manner in which he/she describes the food with the available icons, and/or activity input, each user can have different food unit values assigned to the same indication for a food item(s). The effect of activity on the balance of energy can be calculated, not directly against the food unit intake but it can be first processed, by the app 120, through a separate algorithm, e.g., imbedded in the calculation of the intrinsic metabolism. Thus, neither food nor activity directly affects the energy balance or fitness arc 334, but can be instead analyzed based upon their historic and/or learned impact on intrinsic metabolism. The app 120 thus can create an ongoing user profile of intrinsic metabolism, activity, and food choice/amount that can be unique to each user. In an embodiment, the various components of app 120 may be calculated periodically, e.g., at 10 minute intervals, although other intervals can be also applicable. In an embodiment, it may take the app 120 about two weeks to define and calculate the user's metabolic profile and assign the values to his/her activity units and food intake units. It can be understood that such analysis can be further refined and adjusted by the selection of a target weight by the user.

As disclosed above, the four components or parameters used by the algorithms in the app 120 can be indicated food intake (and, thus, apparent calories consumed), indicated type and amount of activity, e.g., exercise (and thus, apparent calories burned through activity), weight, and finally the calories necessary to maintain basic physiologic function, i.e., intrinsic metabolism. The app 120, therefore, can begin a monitoring process by assigning a value to each of the four parameters and running a series of daily calculations to determine the accuracy of the assigned values in relation to one another. The accuracy can be determined, by way of example, on the ability for one set of assigned numbers to accurately predict the others. Based on a weighted numerical coefficient of each data point which can, e.g., vary at specified times of the day and week, the algorithm can, e.g., choose three of the four definable parameters and then calculate the fourth variable, e.g., for one, some or all of the variables.

If the algorithm fails to predict the fourth value accurately, where accuracy can be defined in such a manner that, e.g., if the calculated variable can be reinserted into the app 120, the app 120 accurately predicts the parameters that can be measured at that time, which can be seen as confirming the accuracy of the calculated variable, then new values may be assigned, e.g., to the other variables, and the calculation redone until each variable accurately predicts the others when inserted into the algorithm of the app 120. The variables chosen for analysis may also be seen and learned to vary at different times of the day or week and the app 120 suitably varied to specify that the value can have the greatest accuracy relative to the other values according to the learned/determined variability. This recalculation may also include actual weight which can be directly measured.

The most complicated of the calculations may often be determined to be that of the intrinsic metabolism for a given user. In this case, there may be no direct measurement, and thus the value can be, of necessity, a derived value, which may also vary from user to user and for a given user over time and in many cases according to one or more variables, e.g., daily, weekly, monthly, seasonally, time of day, exercise schedule and the like. This changing variable for intrinsic metabolism can be, e.g., derived from the dynamic interplay of the measured/indicated variables, which can be, e.g., first referenced against, e.g., the predicted value and/or actual value of each parameter. As data about the individual user can be collected, the learned allowed variance between measured variables can be narrowed. The intrinsic metabolism can be calculated and held as a constant.

However, the intrinsic metabolism may be, e.g., held as a constant only for a prescribed period and recalculated as metabolism for the user changes. In other words, if three of the variables can be measured and a rate of change in weight calculated, a constant can be calculated for the intrinsic metabolism. The constant for intrinsic metabolism currently calculated can then be used to predict weight given the indicated activity and indicated food intake. Should the algorithm fail to accurately predict weight given the indicated activity and food intake for the user, then the constant for intrinsic metabolism can be changed. When the constant for intrinsic metabolism can be found to perform adequately in the algorithm of the app 120, the algorithm can maintain the use of the constant and predict, e.g., using changes in either indicated activity or indicated food intake to predict a cumulative impact on fitness, e.g., as measured by change or lack thereof in weight. The algorithms of the app 120 can then be used to study the relationship between the two ongoing variables, indicated activity and indicated food intake, and combine the variations simultaneously and contemporaneously to each other so that, as an example, as one varies, the other can be determined even without the necessity of direct and absolute measurement for the variable, i.e., in such a way that if the user were to actually consume the entered indicated food intake and/or were to actually perform the indicated/entered number of activity units, then the user's weight would remain unchanged. In other words, the algorithm for the app 120 can adjust to inaccuracies in the indications of the food intake and/or activity level, which, if consistently entered by the user and/or determined by the system 100 from inputs from the user or inputs from a component in the system 100 itself, can still determine a constant for intrinsic metabolism and other metabolic activity of the user so as to accurately predict change in fitness over time, as indicated, e.g., by change in the weight of the user.

The display in the fitness arc 334, by moving in the left or right portions, can be seen to denote how far the user can be from good fitness behavior, e.g., as indicated by weight neutral behavior. The fitness arc 334 scale can be set so that if the combination of indicated food consumption and indicated activity performed produces a full energy excess red arc portion 334b for a given period of time, e.g., for seven days, then the user can have gained a predictable amount of weight, e.g., at least one pound, in that given period of time, e.g., one week. If the combination of indicated food consumed and indicated activity performed produces a full energy deficit green arc portion 334a, again for a given period of time, e.g., for one week, then the user can have lost the predicted at least one pound in that week. In this fashion, an accurate prediction of weight change can be maintained, e.g., as long as the intrinsic metabolism of the user and the user's pattern of identifying indicated food intake and/or indicated activity type and amount also remain the same or essentially so.

Continuing to refer to FIG. 3, a colored diamond-shaped pointer 340 can be movable along a line that represents a range of a health quotient 342. The health quotient 342 can be derived from the running average of the fitness arc value 334c for each day of a month modified by the food type consumed and the user's weight. The health quotient 342 can include the user's present weight and desired or targeted weight (i.e., via direct input), the quantity and type of food consumed (i.e., based on the user's selection of food types and quantities). The health quotient 342 also can include the aerobic activity of the user (such as running) and anaerobic activity (such as resistance training for muscle enhancement) which can be automatically input into the app 120 by the fitness tracker.

As disclosed above, the starting weight and target weight can be input on a user profile input screen. Based on these inputs, one of two conditions can be possible: i) the user can be over weight (i.e., the starting weight can be greater than the target weight), or ii) the user can be at or under the target weight. These two possibilities can be used to govern the health quotient 342. More particularly, in an embodiment, when the health quotient 342 is calculated at the end of each day, the pointer 340 can be positioned in a manner described below.

The health quotient 342 horizontal scale can range, e.g., from −50 units at the left end to +50 units at the right end, although the numerical values for the units are not shown on the scale on FIG. 3. Each month, a running average of available health quotient 342 daily results can be compiled and displayed. When moving from one month to the next, the first day of each month can be equivalent to the final figure from the previous month, and it can be weighted as only one day of that month. As shown in FIG. 3, the horizontal scale can be divided into four portions moving left to right. The first portion extends from −50 to −25 and can be labeled “fit”, the second portion extends from −25 to 0 and can be labeled “healthy”, the third portion extends from 0 to +25 and can be labeled “unhealthy”; and the forth portion extends from +25 to +50 and can be labeled “health risk”. In an embodiment, each portion may have color coding varying from “fit” to “health risk” such as dark green, green, yellow, and red, respectively. The position of the pointer 340 on the horizontal scale can be used to represent, at the end of each day, that month's average of health quotient 342 values over the available days in the month. Furthermore, the health quotient 342 units can be the fitness arc values 334c of the fitness arc 334 at the end of each day.

In an embodiment, the health quotient 342 may also take account of the distribution of the calories consumed throughout the day. More particularly, the waking hours are divided into four quadrants. If 20 percent of the total food consumption is consumed in each of the four quadrants, then the pointer 340 will shift to the left by three units, and if not, it will shift to the right by three units. The remaining 20 percent can be consumed in any of the four quadrants without effecting the health quotient 342.

In the circumstance where the user is over weight (i.e., the starting weight can be greater then the target weight), the pointer 340 can point to a point to the left of −24. The user could thus be in the “healthy” range but not in the “fit” range. Food selection can also modify the final number. Each food item can be assigned a color: for example red for poor quality, yellow for neutral quality, and green for high quality food. Further, when consumption of 51% of food is good quality or poor quality then the following modifiers can be activated, and if consumption of either the good or poor quality food does not reach 51%, then these modifiers may not be activated. The modifiers and their triggers can be:

If 51 percent of food consumption is “good quality” and the user is overweight then the final fitness arc 334 can have a negative value, e.g., 12 units added to fitness arc value 334c and the pointer 340 can be shifted to the left. If 51% of food consumption is poor quality, then the pointer 340 can be shifted to the right, e.g., by 12 units.

If the user is at or under target weight and 51% percent of food consumption is “good quality” then the pointer 340 can be shifted, e.g., (50+12) or 62 points to the left. If 51% of food consumption is “poor quality”, then, as described above, the pointer 340 can be shifted, e.g., to the right by 12 units.

The system 100 can also reference food intake with change in the user's weight and fitness activity to develop the user's intrinsic metabolism. As described above, the system 100 may adjust the prediction of changes in the health of the user on a daily basis based on input values from the user regarding weight, food intake and fitness activity.

In one embodiment, the fitness tracker app 120 collects six data sets: 1) amount of food the user eats, 2) quality of food eaten, 3) amount of activity, 4) types of activity, 5) sleep patterns, and 6) metabolism. In analyzing these six influencers of health, many data points (e.g., over 35 data points) can be collected.

In one embodiment, the user cannot modify the data collected and displayed on the app 120. The user can view the data 125, 135, and the medical professional can manipulate the data 135.

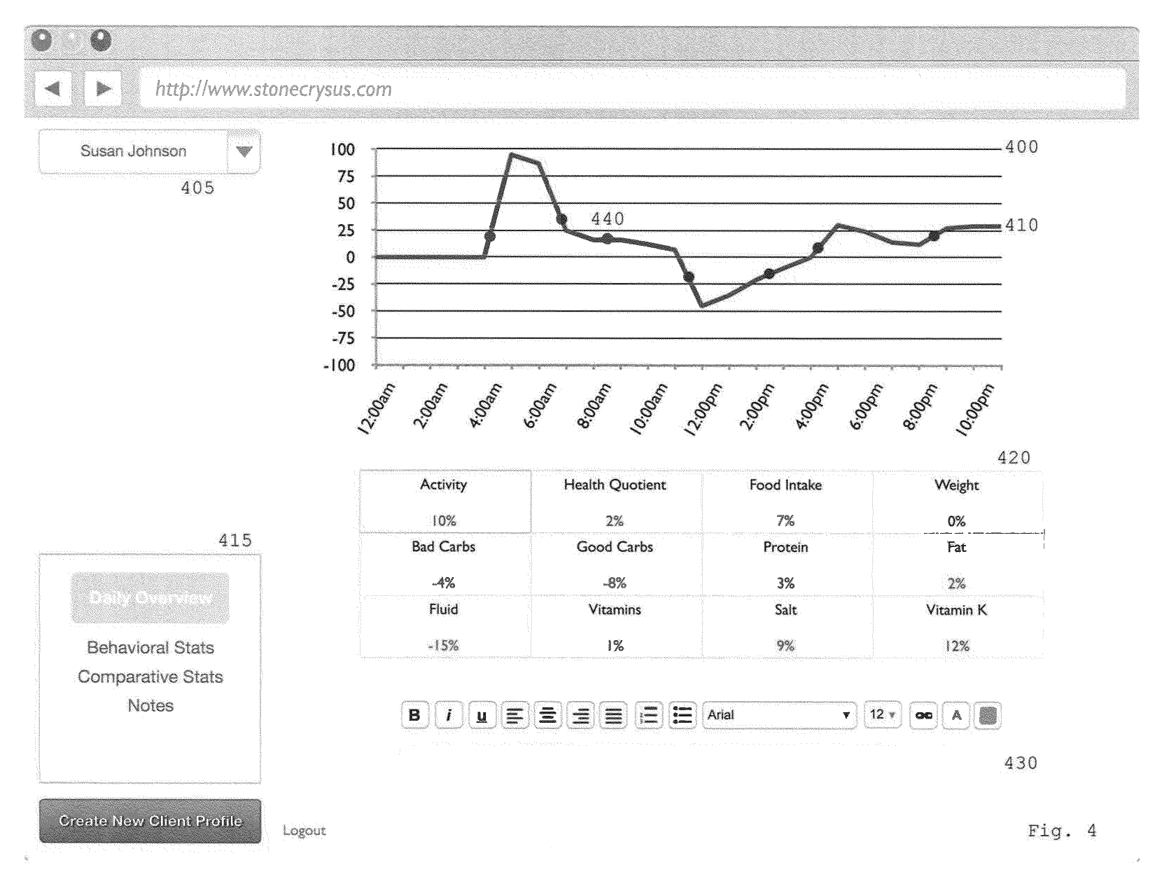

FIG. 4 illustrates a screen shot 400 provided on a website associated with the fitness tracker module 130. The medical professional first selects a user in user selection input 405 (as shown, Susan Johnson). In another embodiment, the medical professional selects the user in an introduction screen. Once the user is selected, a line graph 410 is shown illustrating the arc 334 throughout the day in a different form. The line graph 410 tracks the fitness arc 334 readings throughout the day for the selected user. If a point or section of the line graph 410 is at or near 100% (y-axis), the user was fully on the left side of the arc 334 (energy deficit). If a point or section of the line graph 410 is at or near −100% (y-axis), the user was fully on the right side of the arc 334 (energy excess). 0% represents the middle of the arc 334. This graph 410 provides the medical professional with a representation of where the user was in the arc at each moment in the day to enable the viewing of how the user's habits affected their health. For example, the medical professional can determine that the user is not healthy in the morning but healthy in the afternoon and evening. As shown in line graph 410, the user has a high energy deficit at approximately 5 am (e.g., didn't eat breakfast and went for a run). Although described herein as data throughout or for the day, any predetermined time period can be used (e.g., several days, a week, an hour, etc.)

In one embodiment, if the medical professional uses his or her mouse or pointing device to hover over a specific point on the line graph 410, the point will show the percentage away from the center (user's average) of the fitness arc 334 (e.g., 23% away from the center in a positive direction). Ideally, if the goal of the user is to lose weight, the medical professional wants to see an energy deficit. If the user's goal is to gain weight (e.g., to gain muscle), the medical professional will want to see an energy excess.

This line graph 410 occurs in an overview screen (e.g., daily overview screen), which can be selected via a data selection input 415. Although shown as a line graph 410, any graphical representation of the fitness arc 334 can be presented to the medical professional.

In one embodiment, the screen shot 400 also includes data points or boxes 420 showing a snapshot of the user's health characteristics for the day. The data points 420 include activity, health quotient, food intake, weight, bad carbs, good carbs, protein, fat, fluid, vitamins, salt, and vitamin K. Although shown with specific data points 420, other data points may be represented instead of or in addition to the data points shown. The number inside each data box represents the daily value and is colored a particular color to represent a comparison of that value to the value during the previous day. In one embodiment, a positive change is represented with a green number (e.g., activity), a negative change is represented with a red number (e.g., good carbs), and no change is represented with a black number (e.g., weight). Thus, in the example shown, the user ate 8% less good carbs than the amount of good carbs eaten on the previous day or as it relates to their goal as determined by computer 105 analysis.

In one embodiment, the medical professional can write and/or send notes about/to the user via a notes section 430. A note may be in response to analysis of the line graph 410 and/or the data points 420. In the notes section 430, the medical professional can type and edit notes (for record keeping) that may be sent to the fitness tracker app 120 for viewing by the user. In one embodiment, if the medical professional hovers over a node (e.g., node 440) on line graph 410, a note sent to the user or a note recorded will be displayed. Thus, the nodes represent times at which a note was sent to the user or was recorded. For example, at 2 pm the medical professional may write a note to the user indicating “Eat more protein before workout” to alert the user that, to build muscle, the user has to eat more protein before a workout.

Although described herein as a medical professional analyzing and manipulating the data provided by the fitness tracker module 130, any individual (e.g., the user) can analyze and manipulate the data once gaining access to the fitness tracker module 130.

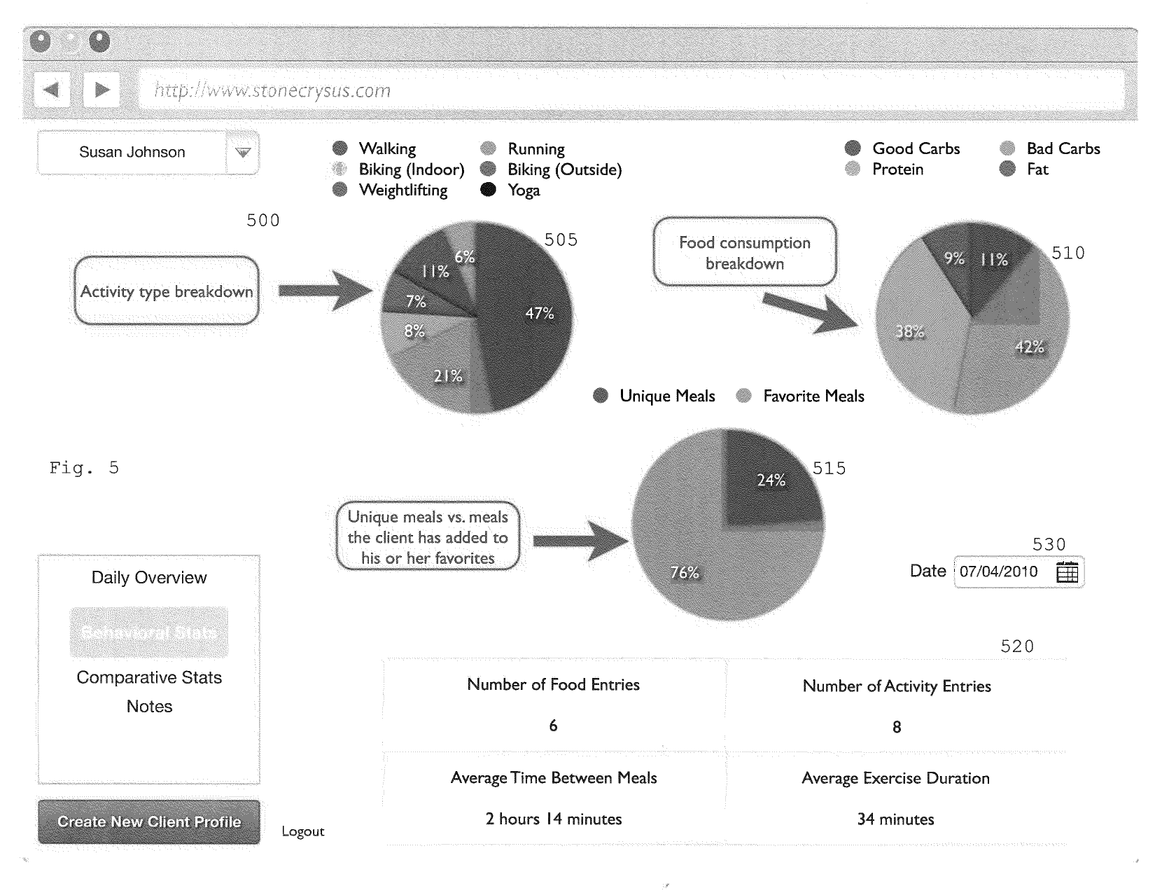

FIG. 5 shows a screen shot illustrating a behavior statistics screen 500. The fitness tracker app 120 (i.e., fitness tracker) can detect the activity the user is performing. In one embodiment, the fitness tracker module 130 segments the activities into walking, biking (indoor), weightlifting, running, biking (outside), and/or yoga. In another embodiment, the fitness tracker module 130 segments the activities into walking, running, weight lifting, and using indoor aerobic equipment. The activities can be segmented in any fashion, such as for example aerobic, anaerobic, and routine activity. In one embodiment, the fitness tracker module 130 can break down percentage of food into good carbs, bad carbs, protein, and/or fat. The module 130 can display one or more graphs showing the breakdown of activity/food (e.g., pie charts 505, 510). In one embodiment, the fitness tracker app 120 or module 130 determines the breakdown of food from the user-inputted food items (as described above with the plate/menu).

The screen 500 can also include a unique meals vs. favorite meals graph 515 or data points. This describes meals the user does not eat often vs. meals the user eats frequently. A benefit of graphing this data is that the medical professional can determine whether the user is obtaining enough variety in their diet, such as if their health plan calls for a varied diet of, e.g., vegetables, fruits, etc. The medical professional may determine that the user is eating the same meal often and may send a note to the user indicating that the user has to add more variety to his or her diet.

In one embodiment, the screen 500 includes behavioral statistics data points 520, which can include, without limitation, number of food entries, average time between meals, number of activity entries, and average exercise duration. In screen 500, the medical professional can change the date that this data is shown with date toggling switch 530 so that the medical professional can compare these graphs 505, 510, 515 and data points 520 over time.

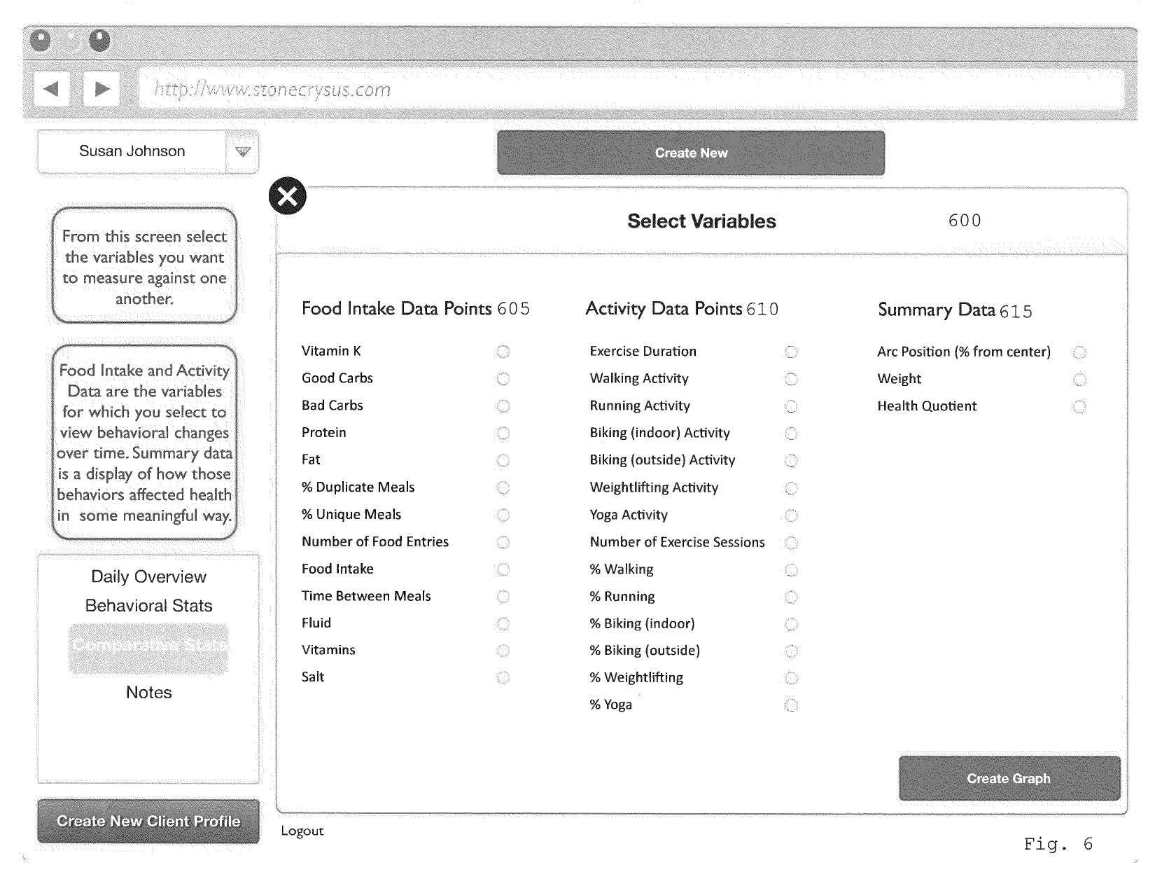

FIG. 6 illustrates an embodiment of a comparative statistics screen shot 600 for the medical professional to select variables to measure against one another. In one embodiment, one variable category includes food intake data points 605 (which can include, e.g., vitamin K, good carbs, bad carbs, protein, fat, % duplicate meals, % unique meals, number of food entries, food intake, time between meals, fluid, vitamins, and/or salt). Another variable category is activity data points 610 (which can include, e.g., exercise duration, walking activity, running activity, biking (indoor activity), biking (outside) activity, aerobic exercise equipment activity (not shown), weightlifting activity, yoga activity, number of exercise sessions, % walking, % running, % biking (indoor), % biking (outside), % weightlifting, % aerobic exercise equipment activity, and/or % yoga). A third variable category includes summary data 615 (which can include, e.g., arc position (% from center), weight, and/or health quotient).

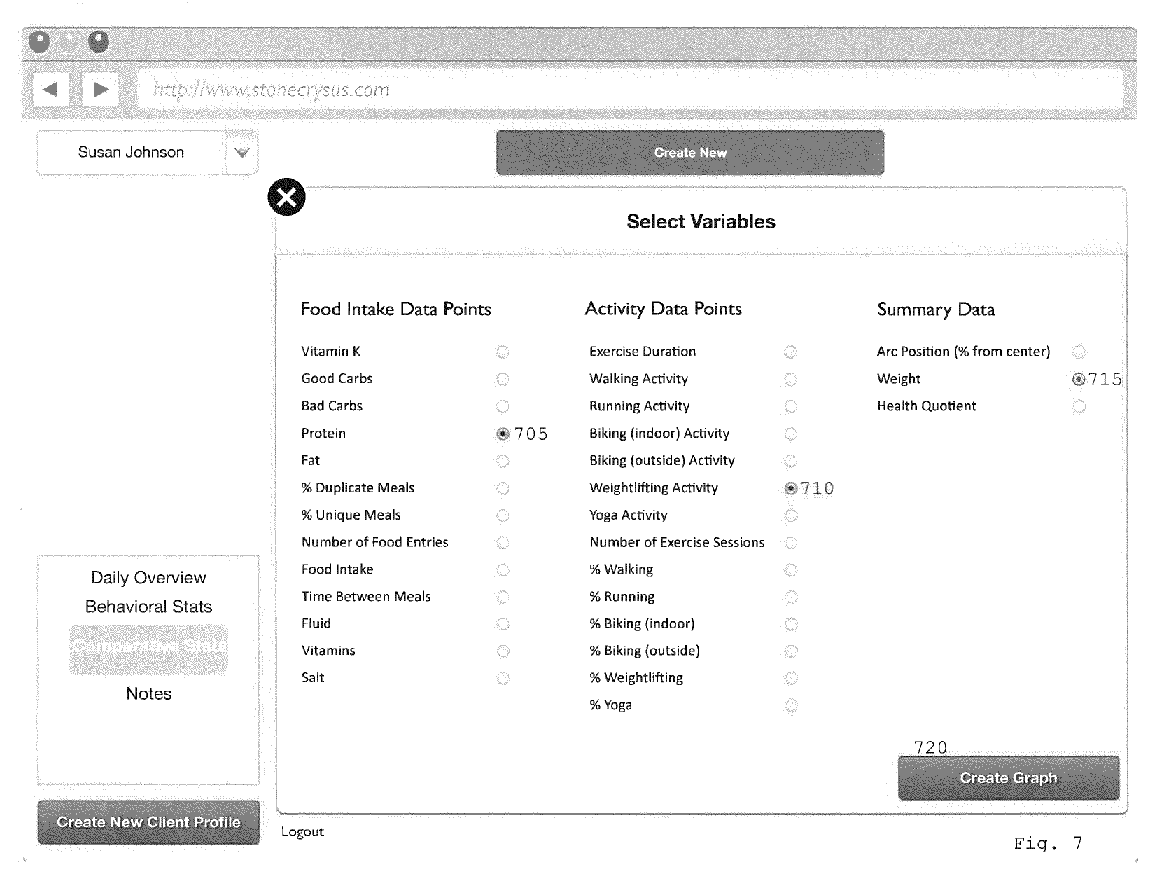

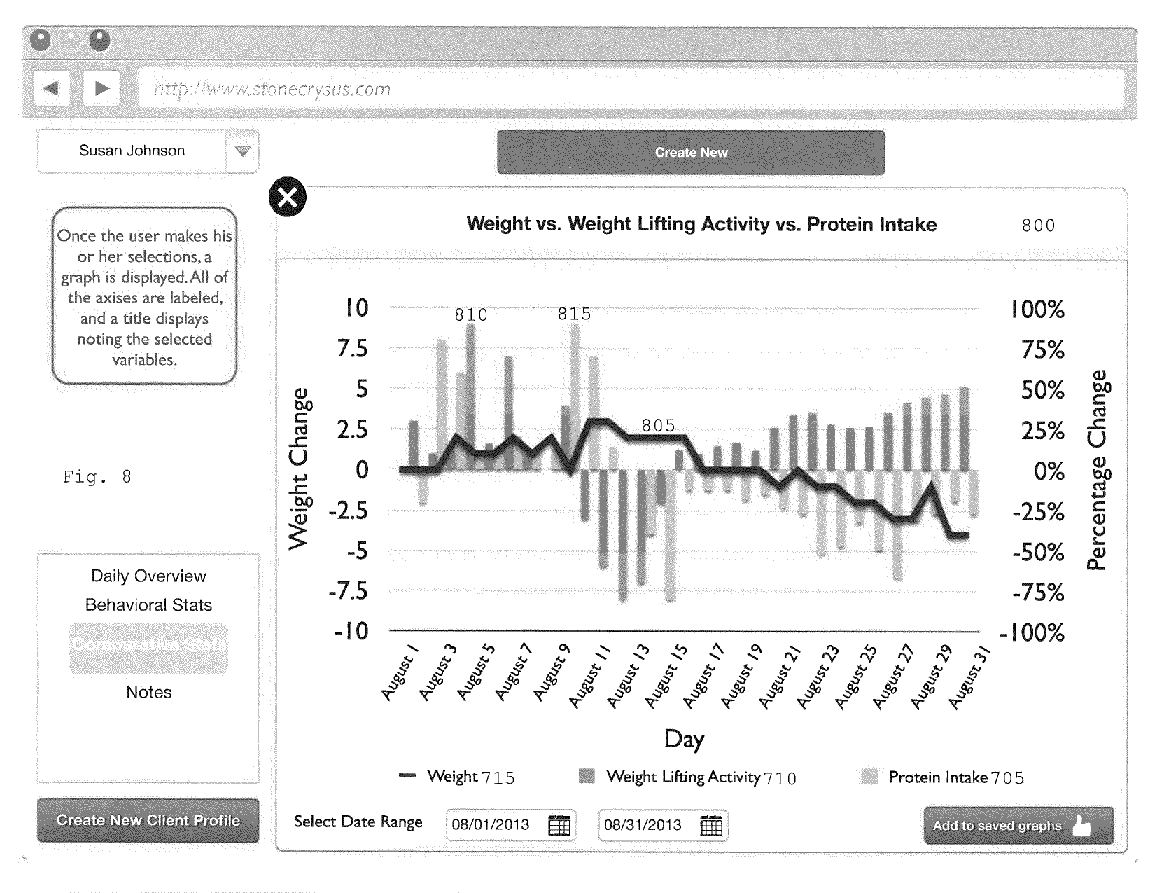

FIG. 7 shows the medical professional selecting three variables to plot against each other—protein 705, weightlifting activity 710, and weight 715. The medical professional selects the Create Graph button 720 to create plot 800 shown in FIG. 8. In plot 800, the summary data 615 (weight 715 here) is represented as line graph 805. The weightlifting activity data 710 is shown as the red bar graph 810. The protein intake data 705 is shown as the grey bar graph 815. This graph is shown for one month (Aug. 1, 2013-Aug. 31, 2013), which can be changed from one day to multiple years and any time frame in-between.

Thus, if a medical professional (e.g., trainer) has a client who wants to gain 5 lbs. of muscle in 4 months, the trainer will put together a training and diet program for the client. At the end of the first month, e.g., the trainer sees that the client has lost weight 715 from plot 800. The trainer sees that weightlifting activity 710 was up at the start of the month, lessened during the middle of the month, and then increased at the end of the month (from bar graph 810). Protein intake 705 was up at the start of the month, and was then lower during the middle and end of the month (from bar graph 815). The trainer therefore determines that the client is not eating enough protein to build muscle. The trainer can then send a note to the client (or instruct the client) to eat more protein to maintain muscle growth. The trainer can also adjust the goal which is represented on the computer 105. Thus, in one embodiment the trainer can change the fitness arc (described below) as well as other goals.

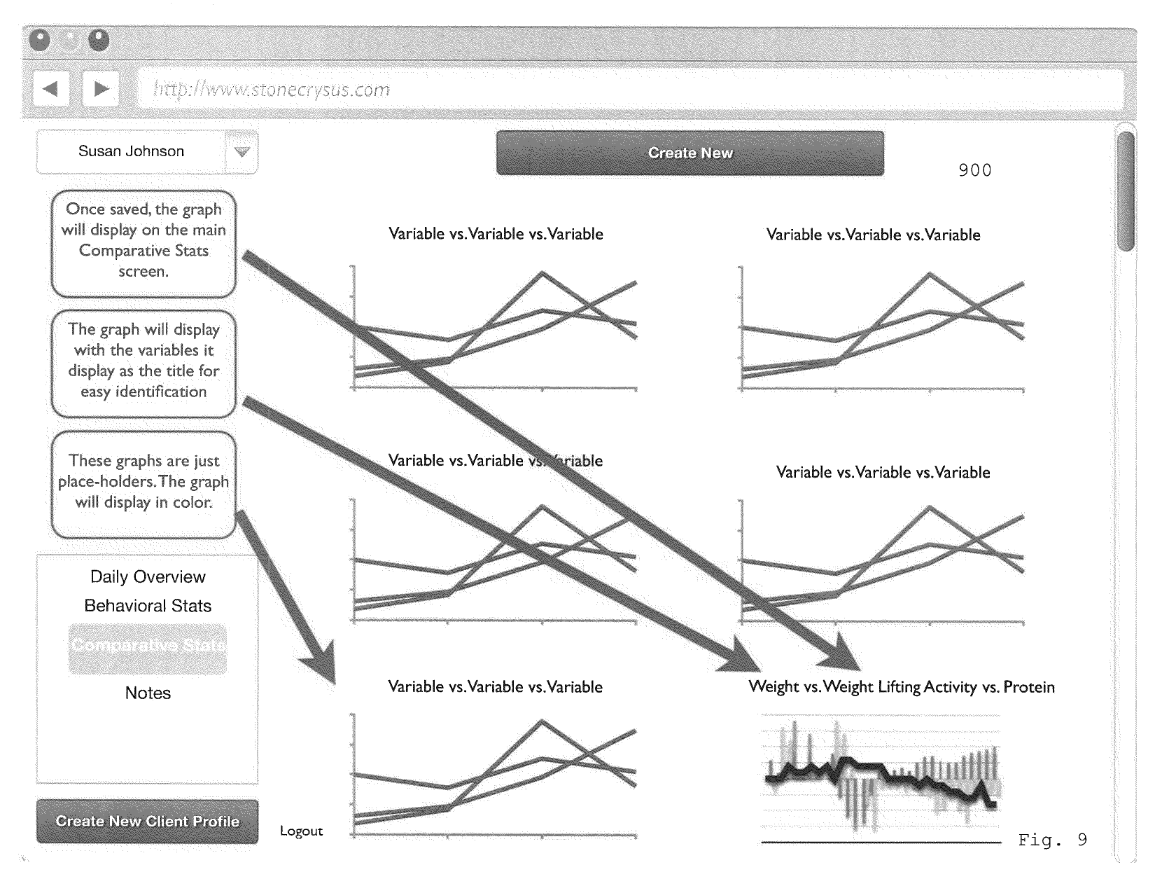

In one embodiment, the weight change 715 is plotted in pounds and the weightlifting activity 710 and protein intake 705 are plotted as a percentage. In one embodiment, the medical professional can save this graph to a saved graphs section if this graph or variables, e.g., will be referred to often or plotted often. Once saved, this graph is shown in the main comparative statistics screen 900, as shown in FIG. 9. If the medical professional clicks on a graph in the main screen 900, the graph will display in the full display screen (or a portion of the display screen). The graph can also be removed from the main comparative statistics screen 900 and therefore be removed from the saved graphs.

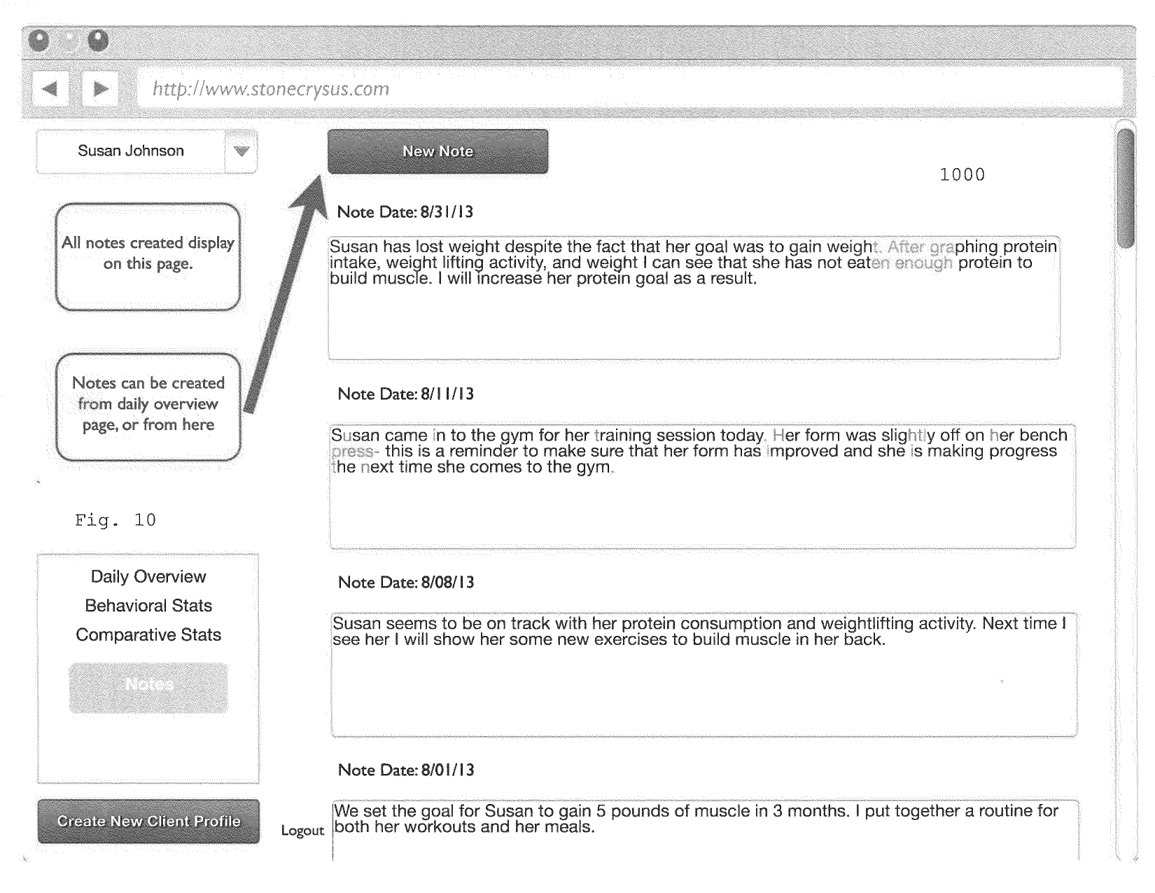

FIG. 10 shows a notes display 1000 illustrating created notes. In the notes display 1000, the medical professional can view existing notes and/or can create new notes. Thus, notes can be created from the Daily Overview page (as described above) or from notes display 1000. In one embodiment, the medical professional can also edit existing notes on the notes display page 1000.

Although described with respect to health and fitness characteristics, the data can relate to sleep patterns or characteristics. The fitness tracker app 120 can display, in an arc, sleep pattern data related to the sleep patterns of the user. This data can be transmitted to the fitness tracker module 130 for manipulation, analysis, and/or graphing.

Further, in one embodiment, the medical professional can use the fitness tracker module 130 to change the fitness arc characteristics on the fitness tracker app 120 based on the analysis and/or graphing of the data. For example, the medical professional may make it 10% harder to obtain an energy deficit (i.e., need 10% more activity to obtain an energy deficit).

In one embodiment, the data collected is leveraged to publish meaningful reports about health trends as it relates to the general user base, as well as specific demographics. In one embodiment, gender, age, and/or location (or any other demographics) are collected.

In one embodiment, the user and their health professionals will be able to record major health events such as child birth, heart attack, etc. In one embodiment, the data will be leveraged to identify any trends that lead to health events of this nature.

In one embodiment, this platform is expanded to include computer-generated analysis. In one embodiment, the computer can analyze the user data to draw its own conclusion(s) for most efficient health improvement.

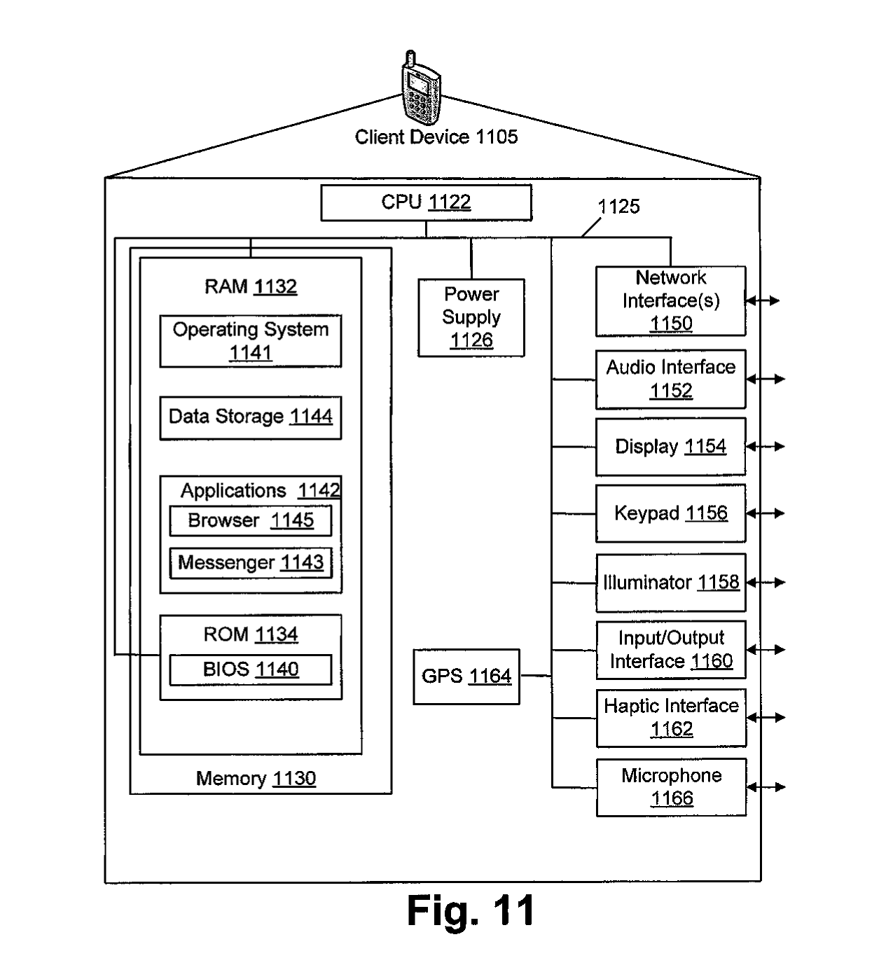

As shown in the example of FIG. 11, client device 1105 may include one or more processing units (also referred to herein as CPUs) 1122, which interface with at least one computer bus 1125. A memory 1130 can be persistent storage and interfaces with the computer bus 1125. The memory 1130 includes RAM 1132 and ROM 1134. ROM 1134 includes a BIOS 1140. Memory 1130 interfaces with computer bus 1125 so as to provide information stored in memory 1130 to CPU 1122 during execution of software programs such as an operating system 1141, application programs 1142, device drivers, and software modules 1143, 1145 that comprise program code, and/or computer-executable process steps, incorporating functionality described herein, e.g., one or more of process flows described herein. CPU 1122 first loads computer-executable process steps from storage, e.g., memory 1132, data storage medium/media 1144, removable media drive, and/or other storage device. CPU 1122 can then execute the stored process steps in order to execute the loaded computer-executable process steps. Stored data, e.g., data stored by a storage device, can be accessed by CPU 1122 during the execution of computer-executable process steps.

Persistent storage medium/media 1144 is a computer readable storage medium(s) that can be used to store software and data, e.g., an operating system and one or more application programs. Persistent storage medium/media 1144 can also be used to store device drivers, such as one or more of a digital camera driver, monitor driver, printer driver, scanner driver, or other device drivers, web pages, content files, playlists and other files. Persistent storage medium/media 1144 can further include program modules and data files used to implement one or more embodiments of the present disclosure.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Client device 1105 can also include one or more of a power supply 1126, network interface 1150, audio interface 1152, a display 1154 (e.g., a monitor or screen), keypad 1156, illuminator 1158, I/O interface 1160, a haptic interface 1162, a GPS 1164, a microphone 1166, a video camera, TV/radio tuner, audio/video capture card, sound card, analog audio input with A/D converter, modem, digital media input (HDMI, optical link), digital I/O ports (RS232, USB, FireWire, Thunderbolt), expansion slots (PCMCIA, ExpressCard, PCI, PCIe).

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

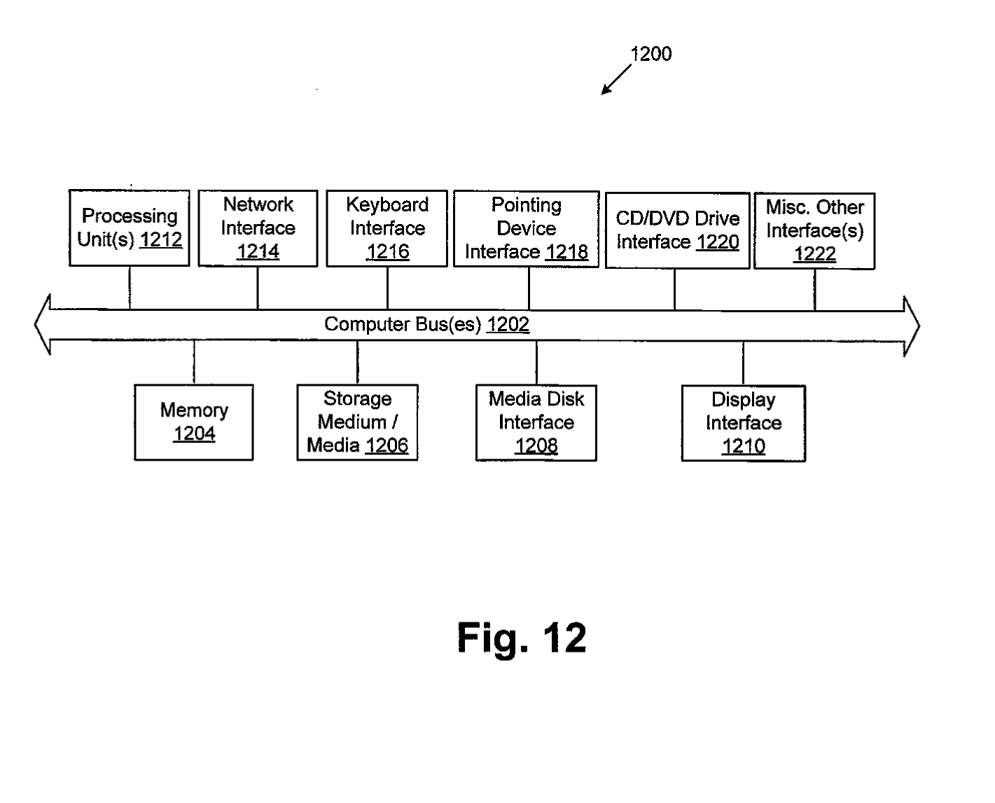

FIG. 12 is a block diagram illustrating an internal architecture of an example of a computer, such as server computer 110 and/or user computer 105, in accordance with one or more embodiments of the present disclosure. A computer as referred to herein refers to any device with a processor capable of executing logic or coded instructions, and could be a server, personal computer, set top box, tablet, smart phone, pad computer or media device, to name a few such devices. As shown in the example of FIG. 12, internal architecture 1200 includes one or more processing units (also referred to herein as CPUs) 1212, which interface with at least one computer bus 1202. Also interfacing with computer bus 1202 are persistent storage medium/media 1206, network interface 1214, memory 1204, e.g., random access memory (RAM), run-time transient memory, read only memory (ROM), etc., media disk drive interface 1208 as an interface for a drive that can read and/or write to media including removable media such as floppy, CD-ROM, DVD, etc. media, display interface 1210 as interface for a monitor or other display device, keyboard interface 1216 as interface for a keyboard, pointing device interface 1218 as an interface for a mouse or other pointing device, and miscellaneous other interfaces (e.g., interfaces 1220, 1222), such as parallel and serial port interfaces, a universal serial bus (USB) interface, and the like (not shown individually).

Memory 1204 interfaces with computer bus 1202 so as to provide information stored in memory 1204 to CPU 1212 during execution of software programs such as an operating system, application programs, device drivers, and software modules that comprise program code, and/or computer-executable process steps, incorporating functionality described herein, e.g., one or more of process flows described herein. CPU 1212 first loads computer-executable process steps from storage, e.g., memory 1204, storage medium/media 1206, removable media drive, and/or other storage device. CPU 1212 can then execute the stored process steps in order to execute the loaded computer-executable process steps. Stored data, e.g., data stored by a storage device, can be accessed by CPU 1212 during the execution of computer-executable process steps.

As described above, persistent storage medium/media 1206 is a computer readable storage medium(s) that can be used to store software and data, e.g., an operating system and one or more application programs. Persistent storage medium/media 1206 can also be used to store device drivers, such as one or more of a digital camera driver, monitor driver, printer driver, scanner driver, or other device drivers, web pages, content files, playlists and other files. Persistent storage medium/media 1206 can further include program modules and data files used to implement one or more embodiments of the present disclosure.

Internal architecture 1200 of the computer can include (as stated above), a microphone, video camera, TV/radio tuner, audio/video capture card, sound card, analog audio input with A/D converter, modem, digital media input (HDMI, optical link), digital I/O ports (RS232, USB, FireWire, Thunderbolt), and/or expansion slots (PCMCIA, ExpressCard, PCI, PCIe).

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the user computing device or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
repeatedly receiving, by a fitness tracker module executed by a processor from a fitness tracker application executing on a client device, data associated with a user of the fitness tracker application;
manipulating, by an individual using the fitness tracker module, the data to generate fitness tracker module data, the fitness tracker module data comprising an overview, behavioral statistics, and comparative statistics;
graphing, by the individual, a portion of the fitness tracker module data into one or more graphical representations of a portion of data of the fitness tracker application; and
communicating, by the fitness tracker module, at least a portion of the fitness tracker module data to the client device for display.

2. The method of claim 1, wherein the fitness tracker application obtains the data from communication with a device comprising an accelerometer.

3. The method of claim 2, wherein the user wears the device.

4. The method of claim 1, wherein the fitness tracker application displays a fitness arc indicating energy excess and energy deficit of the user during a first predetermined time period.

5. The method of claim 4, further comprising graphing, by the processor, data corresponding to the fitness arc in a line graph over a second predetermined time period.

6. The method of claim 5, further comprising displaying, by the processor, data points in display boxes showing a snapshot of the user's health characteristics during the second predetermined time period.

7. The method of claim 6, wherein the health characteristics comprise a health characteristic type selected from a group of health characteristic types consisting of activity, health quotient, food intake, weight, bad carbohydrates, good carbohydrates, protein, fat, fluid, vitamins, salt, and vitamin K.

8. The method of claim 7, wherein the activity is selected from the group consisting of sleeping, walking, jogging, running, biking, tennis, basketball, soccer, circuit training, elliptical training, weight lifting, yoga, Pilates and resistance training.

9. The method of claim 1, wherein the behavioral statistics further comprises a statistic selected from a group of statistic types consisting of aerobic, anaerobic, routine activity, unique meals, favorite meals, number of food entries, average time between meals, number of activity entries, and average exercise duration.

10. The method of claim 1, wherein the graphing of the portion of the fitness tracker module data further comprises enabling selection, by the individual, of a plurality of comparative statistics selections from food intake data points, activity data points, and summary data.

11. A computing device comprising:
a processor;
a storage medium for tangibly storing thereon program logic for execution by the processor, the program logic comprising:
receiving logic executed by a fitness tracker module executed by a processor from a fitness tracker application executing on a client device, for repeatedly receiving data associated with a user of the fitness tracker application;
manipulating logic executed by the fitness tracker module for manipulating, by a individual, the data to generate fitness tracker module data, the fitness tracker module data comprising an overview, behavioral statistics, and comparative statistics;
graphing logic executed by the processor for graphing, by the individual, a portion of the fitness tracker module data into one or more graphical representations of a portion of data of the fitness tracker application; and
communication logic executed by the processor for communicating, by the fitness tracker module, at least a portion of the fitness tracker module data to the client device for display.

12. The computing device of claim 11, wherein the fitness tracker application obtains the data from communication with a device comprising an accelerometer.

13. The computing device of claim 11, wherein the fitness tracker application displays a fitness arc indicating energy excess and energy deficit of the user during a first predetermined time period.

14. The computing device of claim 13, further comprising fitness arc graphing logic executed by the processor for graphing data corresponding to the fitness arc in a line graph over a second predetermined time period.

15. The computing device of claim 14, further comprising display logic executed by the processor for displaying data points in display boxes showing a snapshot of the user's health characteristics during the second predetermined time period.

16. The computing device of claim 15, wherein the health characteristics comprise a health characteristic type selected from a group of health characteristic types consisting of activity, health quotient, food intake, weight, bad carbohydrates, good carbohydrates, protein, fat, fluid, vitamins, salt and vitamin K.

17. The computing device of claim 16, wherein the activity is selected from the group consisting of sleeping, walking, jogging, running, biking, tennis, basketball, soccer, circuit training, elliptical training, weight lifting, yoga, Pilates and resistance training.

18. The computing device of claim 11, wherein the behavioral statistics further comprises a statistic selected from a group of statistic types consisting of aerobic activity, anaerobic activity, routine activity, unique meals, favorite meals, number of food entries, average time between meals, number of activity entries and average exercise duration.

19. The computing device of claim 18, wherein the aerobic activity is selected from the group consisting of walking, jogging, running, biking, tennis, basketball, soccer, circuit training and elliptical training.

20. The computing device of claim 18, wherein the anaerobic activity is selected from the group consisting of weight lifting, yoga, Pilates and resistance training.

21. The computing device of claim 18, wherein the routine activity is sleep.

22. The computing device of claim 11, wherein the graphing logic for graphing the portion of the fitness tracker module data further comprises selecting logic executed by the processor for enabling selection, by the individual, of a plurality of comparative statistics selections from food intake data points, activity data points and summary data.

23. The computing device of claim 22, wherein the activity data points are selected from data points for activities selected from the group consisting of sleeping, walking, jogging, running, biking, tennis, basketball, soccer, circuit training, elliptical training, weight lifting, yoga, Pilates and resistance training.

24. A non-transitory computer readable storage medium tangibly storing computer program instructions capable of being executed by a computer processor, the computer program instructions defining the steps of:
repeatedly receiving, by a fitness tracker module executed by a processor from a fitness tracker application executing on a client device, data associated with a user of the fitness tracker application;
manipulating, by a individual using the fitness tracker module, the data to generate fitness tracker module data;
graphing, by the individual, a portion of the fitness tracker module data into one or more graphical representations of a portion of data of the fitness tracker application; and
communicating, by the fitness tracker module, at least a portion of the fitness tracker module data to the client device for display.

25. The non-transitory computer readable storage medium of claim 24, wherein the fitness tracker application obtains the data from communication with a device comprising an accelerometer.

26. The non-transitory computer readable storage medium of claim 24, wherein the fitness tracker application displays a fitness arc indicating energy excess and energy deficit of the user during a first predetermined time period.
